(19) United States
(12) Patent Application Publication
(10) Pub. No.: US 2010/0198715 A1
(43) Pub. Date: Aug. 5, 2010

(54) SYSTEM AND METHOD FOR KEYWORD-BASED TRADING

(75) Inventor: Farah Ahmad, Bangalore (IN)

Correspondence Address: YAHOO! INC.;C/O Ostrow Kaufman & Frankl LLP, The Chrysler Building, 405 Lexington Avenue, 62nd Floor, NEW YORK, NY, 10174, US

(73) Assignee: Yahoo! Inc., Sunnyvale, CA (US)

(21) Appl. No.: 12/363,753

(22) Filed: Jan. 31, 2009

(51) Int. Cl. G06Q 40/00

(52) U.S. Cl. 705/37

(57) ABSTRACT

Embodiments of the present invention provide systems, methods and computer program products for trading keywords in an electronic market system. One embodiment of a method for trading keywords includes presenting one or more keywords and a corresponding first number of shares for the one or more keywords for trade in a market system. An order for trade of a second number of shares corresponding to a given one of the one or more keywords is received, wherein the order for trade comprises an order value for the second number of shares corresponding to a given one of the one or more keywords. A market value for the second number of shares corresponding to the given one of the one or more keywords is determined and the order for trade for the second number of shares is executed based upon the order value and the market value.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention disclosed herein relates generally to keyword-based trading. More specifically, the present invention provides systems, methods and computer program products for trading keywords in a market system.

### BACKGROUND OF THE INVENTION

The World Wide Web provides access to an extraordinary large collection of content item (in various formats including text, images, videos and other media content) relating to virtually every subject imaginable. To generate revenue, search providers present relevant content to end users in conjunction with advertising through the use of various advertising models. Keywords play a large role in such advertising models. For example, in a Pay Per Click (“PPC”) advertising model used by search engines, advertising networks, and content websites/blogs, advertisers only pay when a user actually clicks on an advertisement to visit the advertiser's website. Advertisers bid on keywords they predict that target users are going to utilize as search terms when searching products or services. A bid value that an advertiser places on a given keyword depends on many factors including search volume, cost and position estimates, search volume trends, and possible negative matches. Minimum prices per click, often referred to as Costs Per Click (“CPC”), vary depending on the search engine.

In the existing on-line advertising schemes, however, the value of a given keyword is limited solely by to what advertisers anticipate as the value of the keyword. Advertisers assess this value on the basis of one or more keyword predictions; assumptions that a target market is to use predicted search terms when looking for a product or service. Such an advertising model prevents parties other than advertisers from positively influencing the value of keywords.

Therefore, there exists a need for systems, methods and computer program products that provide for additional positive valuation of keywords in an on-line advertising model.

### SUMMARY OF THE INVENTION

Generally, the present invention provides for systems, methods and computer program products for trading keywords in an electronic market system. The present invention is directed toward a method for trading keywords and includes presenting one or more keywords and a corresponding first number of shares for the one or more keywords for trade in a market system. An order for trade of a second number of shares corresponding to a given one of the one or more keywords is received, wherein the order for trade comprises an order value for the second number of shares corresponding to a given one of the one or more keywords. A market value for the second number of shares corresponding to the given one of the one or more keywords is determined and the order for trade for the second number of shares corresponding to the given one of the one or more keywords is executed based upon the order value and the market value.

The present invention provides systems, methods and computer program products to trade keywords in an electronic market system that addresses the limitations of current techniques in positively valuating keywords in on-line advertising. By allowing traders to buy and sell keywords in the form of shares, traders can influence the value of keywords in the present time period by trading shares of keywords. For example, by placing a keyword in a keyword-based market system, traders can purchase shares of a keyword as art of an initial offering, indicating to advertisers what the potential market for the specific keyword may and consequently increasing the value of the keyword by requiring to advertisers to bid on keywords at the expected value during the present time period. In exchange, traders receive the benefit of receiving annual dividends from the shares of keywords, which may depend on factors such as annual search volume, transaction volume and the CPC of a given keyword.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a block diagram of a system for trading keywords in a keyword-based market system according to one embodiment of the present invention;

FIG. 2 illustrates a flow diagram presenting a method for trading keywords in a keyword-based market system according to one embodiment of the present invention;

FIG. 3 illustrates a flow diagram presenting a method for trading keywords using a market order in a keyword-based market system according to one embodiment of the present invention;

FIG. 4 illustrates a flow diagram presenting a method for trading keywords using a conditional order in a keyword-based market system according to one embodiment of the present invention; and

FIG. 5 illustrates a flow diagram presenting a method for trading keywords using a pair order in a keyword-based market system according to one embodiment of the present invention.

### DETAILED DESCRIPTION OF THE INVENTION

In the following description of the embodiments of the invention, reference is made to the accompanying drawings that form a part hereof, and in which is shown by way of illustration, exemplary embodiments in which the invention may be practiced. It is to be understood that other embodiments may be utilized and structural changes may be made without departing from the scope of the present invention.

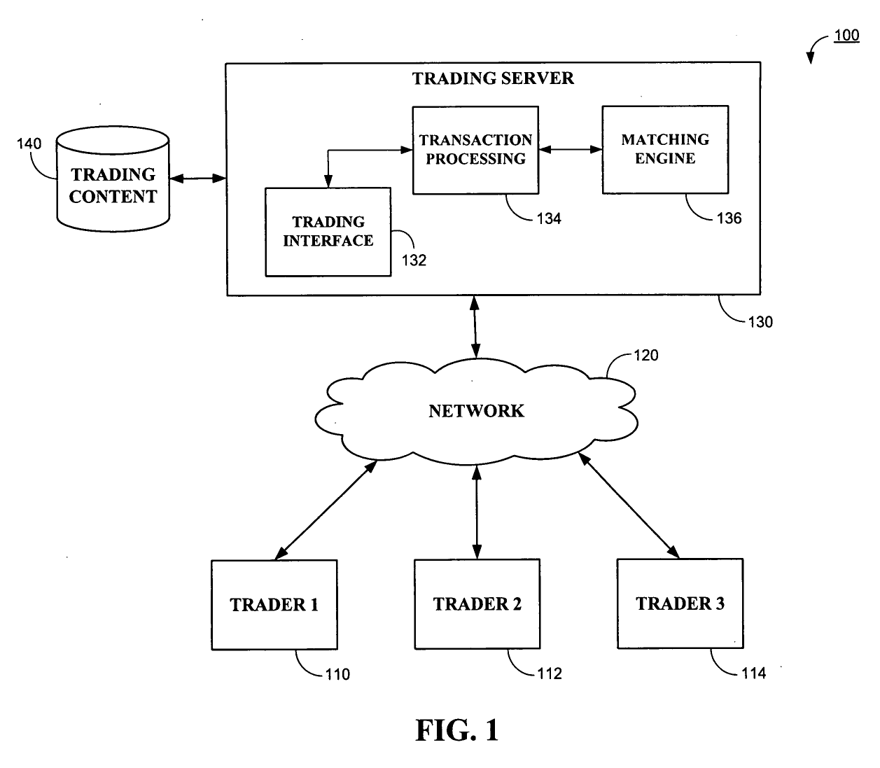

FIG. 1 illustrates one embodiment of a system 100 for trading keywords in a keyword-based market system that comprises a first trader client 110, a second trader client 112, a third trader client 114, a computer network 120, a trading server 130 and a trading content database 140. The trading server 130 may comprise one or more of a trading interface 132, a transaction processing module 134 and a matching engine 136.

The computer network 120 may be any type of computerized network capable of transferring data, such as the Internet. According to one embodiment of the invention, a first trader computer 110, a second trader computer 112 and a third trader computer 114 are general purpose personal computers comprising a processor, transient and persistent storage devices, input/output subsystem and bus to provide a communications path between components comprising the general purpose personal computer. For example, a 3.5 GHz Pentium 4 personal computer with 512 MB of RAM, 40 GB of hard drive storage space and an Ethernet interface to a network. Other client devices are considered to fall within the scope of the present invention include, but are not limited to, hand held devices, set top terminals, mobile handsets, PDAs, etc. Embodiments of the present invention are not limited to only a first trader client 110, a second trader client 112 and a third trader client 114 and may comprise additional, disparate client devices. The first trader client 110, the second trader client 112 and the third trader client 114 are therefore presented for illustrative purposes representative of disparate client devices operative to communicate with the trading server 130 via the network 120.

According to one embodiment of the invention, the trading server 130 is a programmable processor-based computing device that includes persistent and transient memory, as well as one or more network connection ports and associated hardware (not pictured) for transmitting and receiving data on the network 120. The trading server 130 may be operative to host one or more websites, store data, serve ads, etc. Those of skill in the art recognize that the present invention is not limited to only a single trading server 130 and may comprise additional, disparate content providers. The trading server 130 is therefore presented for illustrative purposes representative of multiple providers. Those of skill in the art understand that any number and type of trading server 130 and trader clients 110, 112 and 114 may be connected to the network 120.

The transaction processing module 134 and the matching engine 136 may comprise one or more processing elements operative to perform processing operations in response to executable instructions, collectively as a single element or as various processing modules, which may be physically or logically disparate elements. The trading content data store 140 may be one or more data storage devices of any suitable type, operative to store corresponding data therein. Those of skill in the art recognize that the trading server 130 may utilize more or fewer components and data stores, which may be local or remote with regard to a given component or data store.

In accordance with one embodiment, the trader clients 110, 112 and 114 and the trading server 130 are communicatively interconnected via the communications network 120. The trader clients 110, 112 and 114 may access the trading server 130 using the trading interface 132 over the network 120. According to one embodiment, the trading interface 132 is a user interface (which may comprise a graphical user interface or GUI) where users of the trader clients 110, 112 and 114 may view keyword market information the trading interface 132 receives over the network 120 for display to the user. The keyword market information may include a listing of keywords available on the market, the corresponding number of shares that have been issued for a given keyword, the current number of shares available for trade and the current market value for shares corresponding to a given keyword. Those of skill in the art recognize the list of information is not intended to be limiting, and may include additional number and types of information for the facilitation of keyword trading that may be made available via the trading interface 132.

The trading client 110, 112 and 114 may access the trading interface 132 at the trading server 130 to view the listing of information in order to trade shares of one or more keywords. For example, a trader using the trading client 110 may access the trading server 130 using the trading interface 132 to place an order to buy or sell 20 shares of the keyword “auto.”

The transaction processing module 134 at the trading server 130 may track incoming transactions from traders utilizing trading clients 110, 112 and 114. For example, the transaction processing module 134 may acknowledge that a trader using the trading client 110 is placing an order to buy or sell twenty (20) shares of the keyword “auto.” The transaction processing module 134 may pass a request to the matching engine 136 of the trading server 130 to determine the current market value of shares for the one or more keywords for which the trader is placing an order. Continuing from the previous example, upon acknowledging the receipt of an order for the purchase or sale of twenty (20) shares of the keyword “auto,” the transaction processing module 134 instructs the matching engine 136 to determine the current market value a share of the keyword “auto.”

According to one embodiment, the matching engine 136 makes determination as to the current market value of shares for one or more keywords in association with the trading content database 140. The trading content database 140, according to one embodiment, maintains a library of available trades that can be matched. For example, the trading content database 140 may maintain a listing of keywords that have been made available in the keyword-based market system through a registration process, as well as a corresponding listing of the number of available shares for a given keyword and the current market value for available shares of the keyword.

The matching engine 136 makes the determination as to the current value for shares of one or more keywords by matching the number of shares requested in an order for trade with the available number of shares for one or more keywords listed in the trading content database 140. According to one embodiment, the matching engine 136 transmits the current market value for a share of the requested keyword to the transaction processing module 134. According to another embodiment, the matching engine 136 transmits the current market value for the total number of shares requested in the order for a keyword to the transaction processing module 134. For example, the matching engine 136 may communicate with the transaction processing module 134 and indicate that the current market value for twenty shares for the keyword “auto” is forty dollars, that is, two dollars per share.

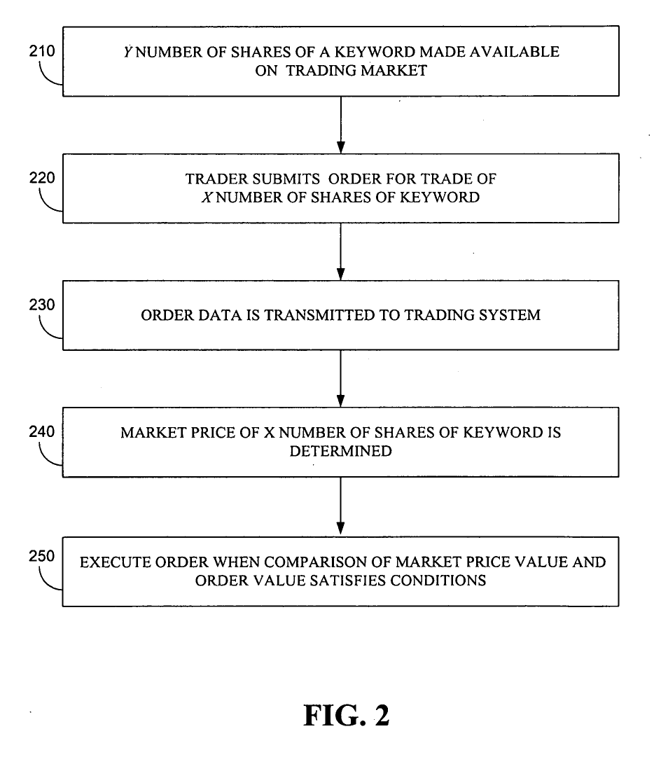

The transaction processing module 134 may make a determination as to whether the order placed by the trader for the purchase or sale of shares of one or more keywords should be executed. Continuing from the previous example, the transaction processing module 134 may make a determination as to whether the order to buy or sell twenty (20) shares of the keyword “auto” should be executed on the basis of conditions placed by the trader with respect to the market price. Methods for determining whether an order for trading shares of one or more keyword should be executed is described in further detail below with respect to the description of FIG. 2 through 5.

The transaction processing module 134 may transmit the status of the transaction to the trading interface 132. For example, the transaction processing module 134 may transmit an indication that the order for purchase or sale of shares of the keyword has been executed. A trader using the trader clients 110, 112 and 114 may view the status of the order using the trading interface 132 over the computer network 120.

FIG. 2 illustrates a flow diagram presenting a method for trading keywords in a keyword-based market system according to one embodiment of the present invention. FIG. 2 is intended to illustrate a high-level description of a method for trading keywords in a keyword-based market system, wherein keywords are the traded commodity in the market system. In accordance with the embodiment of FIG. 2, the method begins by making Y number of shares of a keyword available on a trading market, step 210. For example, in the keyword-based market system, the keyword “motorcycles” may be made available with a corresponding number of shares available for purchase.

According to one embodiment of FIG. 2, a keyword is made available as an initial offering by registering the keyword on the keyword-based market with a corresponding Y number of shares that represents an initial number of shares for that keyword available for purchase. Continuing from the previous example, the keyword “motorcycles” may be made available for the first time on the keyword-based market as an initial offering with a corresponding 1000 shares. Such registration information may be stored in a database, e.g., the trading content database 132 of FIG. 1.

According to another embodiment, a keyword may have previously been registered on the keyword-based market and only a portion of the initial number of shares for a keyword are available due to the fact that a portion of the initial number of shares were purchased and owned by other traders. In such an instance, the corresponding Y number of shares represents those shares that are currently available for the keyword. Continuing from the previous example, 400 shares of the keyword “motorcycles” may be available on the keyword-based market.

A trader may then submit an order for trade of X number of shares of the keyword, step 220. Whether the number of shares that are made available is due to an initial offering or as a result of an already available offering, a trader may submit an order for trade of X number of shares of the keyword. According to one embodiment, Y=X, such that the trader submits an order for the purchase of all of the available shares. For example, where the number of shares made available for a keyword as part of an initial offering, a trader may submit an order for the purchase of all of the shares for that keyword. According to another embodiment, Y>X, such that the trader submits an order for the purchase of only a portion of the available shares of the keyword. For example, a trader may submit an order for the purchase of a number of shares that is less than the number of shares that are available for the keyword.

The order data is transmitted to the trading system, step 230. For example, for the keyword “motorcycles,” a trader may submit an order for the purchase of 100 shares. This order information may be transmitted to the keyword-based market using a user interface of the keyword-based market system, such as the trading interface of FIG. 1, which is tracked by a transaction processing module. The market price of X number of shares of the keyword is determined, step 240. The market price for shares of a keyword is the current market value of the available shares for a keyword in the keyword-based market system. As described with respect to FIG. 1, a the market price of shares of a keyword mat be determined by a matching engine that searches a trading content database to determine what the current market value is for available shares of a keyword. Continuing from the previous example, a matching engine may determine that the market value for 100 shares for the keyword “motorcycles” is US $200.00, where a given share has a current market value of US $2.00.

The order may be executed when comparison of market price value and order value satisfies certain conditions, step 250. According to one embodiment, an order placed for the purchase or sale of shares of a keyword includes supplementary information in addition to the number of shares a trader wants to purchase or sell. Such information may include, but is not limited to, certain conditions or restrictions placed by the trader, such as a minimum monetary value at which the trader is willing to sell shares of the keyword. Continuing from the previous example, the trader may have indicated as part of the order that the purchase of 100 shares of the keyword “motorcycles” should only be executed if the purchase price does not exceed US $225.00. In this instance, the as the market value for the 100 shares for the keyword “motorcycles” does not exceed the order value of US $225.00, the order may be executed.

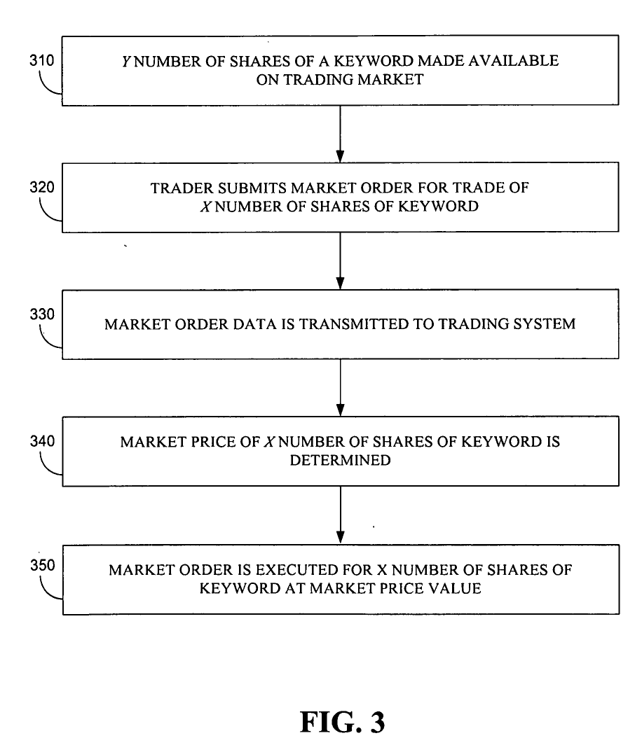

FIG. 3 illustrates a flow diagram presenting a method for trading keywords using a market order in a keyword-based market system according to one embodiment of the present invention. In accordance with the embodiment of FIG. 3, the method begins by making Y number of shares of a keyword available on a trading market, step 310. As presented in the previous example, in a keyword-based market system, 100 shares for the keyword “motorcycles” may be made available. A trader submits a market order for trade of X number of shares of the keyword, step 320. Continuing from the previous example, a trader submits a market order for purchase of all of the available 100 shares of the keyword “motorcycle.” By placing a market order, the trader indicates that there are no limitations with respect to order value that the trader intends on purchasing he shares at, instead indicating that the order should be executed at whatever at the market value of the shares for the keyword is at the time of the order.

The market order data is transmitted to the trading system, step 330. For example, the order for 100 shares for the keyword “motorcycles,” submitted by a trader may be transmitted to the market system indicating that it is a Market Order and that the purchase can be made at the market value. The market price of X number of shares of the keyword is determined, step 340. The market price for shares of a keyword is the current market value of the available shares for a keyword in the keyword-based market system, which may be determined by a matching engine searching a trading content database to determine what the current market value is for the available shares of a keyword. The Market Order is executed for X number of shares of keyword at market price, step 350. Continuing from the previous example, a matching engine may determine that the market value for 100 shares for the keyword “motorcycles” is US $200.00 and execute the order at the market price.

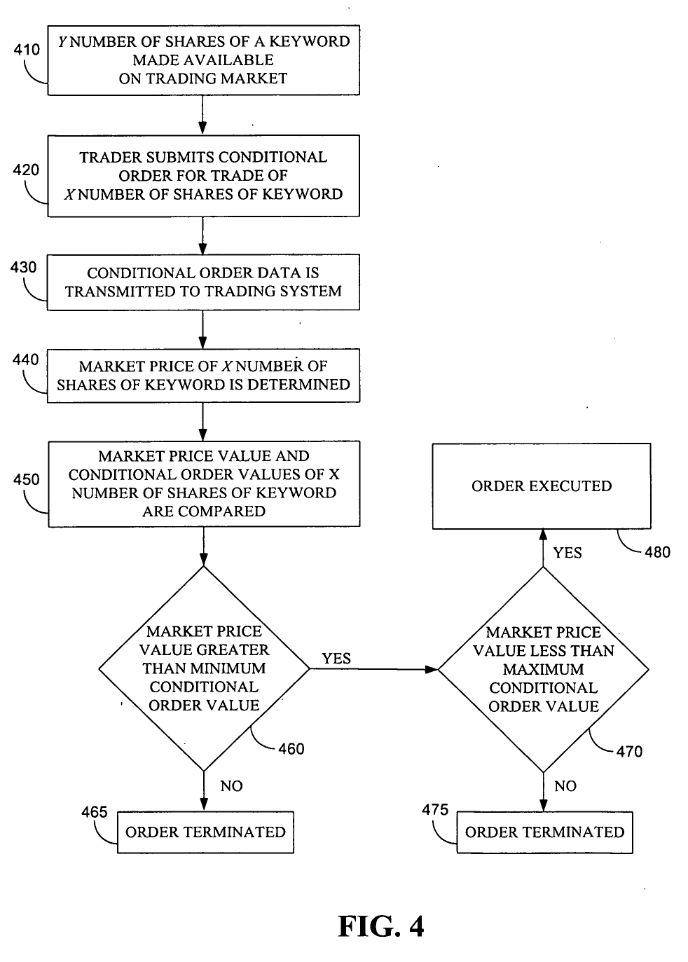

FIG. 4 illustrates a flow diagram presenting a method for trading keywords using a conditional order in a keyword-based market system according to one embodiment of the present invention. In accordance with the embodiment of FIG. 4, the method begins by making Y number of shares of a keyword available on a trading market, step 410. A trader submits a conditional order for trade of X number of shares of the keyword, step 420. For example, a trader may submit a conditional order for purchase of all of the available 100 shares of the keyword “motorcycle.” By placing a conditional order, the trader indicates that there are certain limitations with respect to the order value that the trader intends on purchasing the shares at. According to one embodiment, a conditional order may impose a maximum and a minimum conditional order value, where the maximum conditional order value is a maximum value that the trader is willing to purchase or sell the shares at and the minimum conditional order value is the minimum value that trader is willing purchase or sell the shares at.

The conditional order data is transmitted to the trading system, step 430. Continuing from the previous example, the conditional order for purchase of all of the available 100 shares of the keyword “motorcycle” submitted by the trader is transmitted along with supplementary information indicating that the minimum conditional order value is US $150.00 and the maximum conditional order value is US $250.00. The market price of X number of the keyword is determined, step 440. Continuing from the previous example, a matching engine may determine that the market value for 100 shares for the keyword “motorcycles” is US $200.00.

The market price value and the conditional order values of X number of shares of the keyword are compared, step 450. Continuing from the previous example, the maximum and minimum conditional order values for the conditional order of 100 shares for the keyword “motorcycles” is compared to the market value of US $200.00. A determination is made as to whether the market price value of X number of shares of the keyword is greater than the minimum Conditional Order value, step 460. If the market price value is less than the minimum Conditional Order value, the order terminates at step 465. If the market price value is indeed greater than the minimum conditional order value, a determination is then made as to whether the market price value of X number of shares of the keyword is less than the maximum conditional order value, step 470. If the market price value is less than the maximum conditional order value, the order executes at step 480, otherwise the order terminates, step 475. Continuing from the previous example, as the market value for the 100 shares for the keyword “motorcycles” at US $200.00 is greater than the minimum conditional order value of $150.00 and less than the maximum conditional order value of $250.00, the order for purchase of the 100 shares is executed.

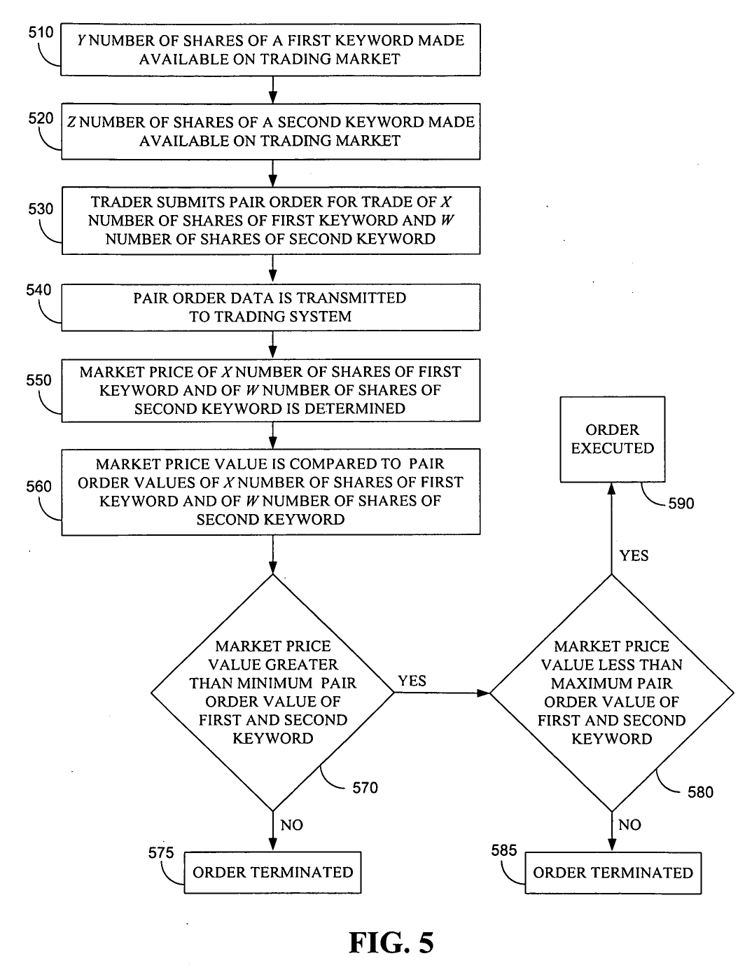

FIG. 5 illustrates a flow diagram presenting a method for trading keywords using a pair order in a keyword-based market system according to one embodiment of the present invention. In accordance with the embodiment of FIG. 5, the method begins by making Y number of shares of a first keyword available on a trading market, step 510. Z number of shares of a second keyword are also made available on the trading market, step 520. For example, a first keyword “motorcycle” may be made available on the trading market with a corresponding 100 shares, as well as a second keyword “helmet” may be made available with a corresponding 200 shares.

A trader submits a pair order for purchase of X number of shares of the first keyword and W number of shares of the second keyword, step 530. By placing a pair order, the trader indicates that there is an order being placed for a pair of keywords with certain limitations with respect to the order value at which the trader intends on purchasing the shares of a given keyword. According to one embodiment, a pair order may impose a maximum and a minimum conditional order value for a given keyword, where the maximum conditional order value is a maximum value that the trader is willing to purchase or sell the shares of a given keyword at and the minimum conditional order value is the minimum value at which the trader is willing purchase or sell the shares of a given keyword.

The pair order data may be transmitted to the trading system, step 540. Continuing from the previous example, the pair order for purchase of all of the available 100 shares of the keyword “motorcycle” and all of the available 200 shares of the keyword “helmet” submitted by the trader is transmitted along with supplementary information indicating that the minimum conditional order value for the keyword “motorcycle” is US $150.00 and for the keyword “helmet” is US $300.00. In addition, the supplementary information for the pair order may indicate that the maximum conditional order value for the keyword “motorcycle” is US $250.00 and for the keyword “helmet” is $500.00. The market price of X number of shares of the first keyword and of W number of shares of the second keyword is determined, step 550. Continuing from the previous example, a matching engine may determine that the market value for 100 shares for the keyword “motorcycle” is US $200.00 and for the keyword “helmet” is US $400.00.

The market price value is compared to the pair order values of X number of shares of the first keyword and of W number of shares of the second keyword, step 560. Continuing from the previous example, the maximum and minimum conditional order values for the pair order of 100 shares for the keyword “motorcycle” is compared to the market value of US $200.00. Similarly, the maximum and minimum conditional order values for the pair order of 200 shares for the keyword “helmet” is compared to the market value of US $400.00.

A determination is then made as to whether the market price value of X number of shares of the keyword is greater than the minimum pair order value of the first and second keyword, step 570. If the market price value is less than the minimum pair order value for the first and second keyword, the order terminates at step 575. If the market price value is indeed greater than the minimum pair order value for the first and second keyword, a determination is then made as to whether the market price value is less than the maximum pair order value of the first and second keywords, step 580. If the market price value is less than the maximum pair order value, the order executes at step 590, otherwise the order terminates, step 585. Continuing from the previous example, as the market value for the 100 shares for the keyword “motorcycle” at US $200.00 and the market value for the 200 shares for the keyword “helmet” at US $400.00 is greater than the respective maximum and minimum conditional order values for the keywords “motorcycle” and “helmet,” the order for purchase of the 100 shares for the keyword “motorcycle” and of 200 shares for the keyword “helmet” is executed.

In accordance with the foregoing description, the present invention provides systems, methods and computer program products to trade keywords in an electronic market system that addresses the limitations of current techniques in positively valuating keywords in on-line advertising. By allowing traders to buy and sell keywords in the form of shares, traders can influence the value of keywords in the present time period by trading shares of keywords. For example, by placing a keyword in a keyword-based market system, traders can purchase shares of a keyword at an initial offering, indicating to advertisers what the potential market for the specific keyword may and consequently increasing the value of the keyword by requiring to advertisers to bid on keywords at the expected value during the present time period. In exchange, traders receive the benefit of receiving annual dividends from the shares of keywords, which may depend on factors such as annual search volume, transaction volume and the CPC of a given keyword.

FIGS. 1 through 5 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for trading keywords in an electronic market system, the method comprising:
presenting one or more keywords and a corresponding first number of shares for the one or more keywords for trade in a market system;
receiving an order for trade of a second number of shares corresponding to a given one of the one or more keywords, wherein the order for trade comprises an order value for the second number of shares corresponding to a given one of the one or more keywords;
determining a market value for the second number of shares corresponding to the given one of the one or more keywords; and
executing the order for trade for the second number of shares corresponding to the given one of the one or more keywords based upon the order value and the market value.

2. The method of claim 1 wherein receiving an order for trade of a second number of shares corresponding to a given one of the one or more keywords comprises receiving a market order for trade of the second number of shares corresponding to the given one of the one or more keywords.

3. The method of claim 2 wherein executing the order for trade for the second number of shares corresponding to the given one of the one or more keywords based upon the order value and the market value comprises:
executing the market order for trade for the second number of shares corresponding to the given one of the one or more keywords at the market value for the second number of shares corresponding to the given one of the one or more keywords.

4. The method of claim 1 wherein receiving an order for trade of a second number of shares corresponding to a given one of the one or more keywords comprises receiving a conditional order for trade of the second number of shares corresponding to the given one of the one or more keywords, wherein the conditional order comprises a minimum conditional order value and a maximum conditional order value.

5. The method of claim 4 wherein executing the order for trade for the second number of shares corresponding to the given one of the one or more keywords based upon the order value and the market value comprises:
determining whether the market value is greater than the minimum conditional order value;
determining whether the market value is less than the maximum conditional order value;
executing the conditional order for trade where the market value is greater than the minimum conditional order value and less than the maximum conditional order value.

6. The method of claim 1 wherein receiving an order for trade of a second number of shares corresponding to a given one of the one or more keywords comprises receiving a pair order for trade of the second number of shares corresponding to the given one of the one or more keywords, wherein the pair order comprises a minimum pair order value and a maximum pair order value for the second number of shares corresponding to the given one of the one or more keywords.

7. The method of claim 6, further comprising:
receiving the pair order for trade for a third number of shares corresponding to a second one of the one or more keywords, wherein the pair order comprises a minimum pair order value and a maximum pair order value for the third number of shares corresponding to the second one of the one or more keywords;
determining a market value for the third number of shares corresponding to the second one of the one or more keywords;
determining whether the market value for the second number of shares corresponding to the given one of the one or more keywords is greater than the minimum pair order value for the second number of shares corresponding to the given one of the one or more keywords;
determining whether the market value for the second number of shares corresponding to the given one of the one or more keywords is less than the maximum pair order value for the second number of shares corresponding to the given one of the one or more keywords;
determining whether the market value for the third number of shares corresponding to the second one of the one or more keywords is greater than the minimum pair order value for the third number of shares corresponding to the second one of the one or more keywords;
determining whether the market value for the third number of shares corresponding to the second one of the one or more keywords is less than the maximum pair order value for the third number of shares corresponding to the second one of the one or more keywords; and
executing the pair order for trade where the market value is greater than the minimum pair order value for the second number of shares corresponding to the given one of the one or more keywords and for the third number of shares corresponding to the second one of the one or more keywords and less than the maximum pair order value for the second number of shares corresponding to the given one of the one or more keywords and for the third number of shares corresponding to the second one of the one or more keywords.

8. Computer readable media comprising program code that when executed by a programmable causes execution of a method for trading keywords in an electronic market system, the computer readable media comprising:
program code for presenting one or more keywords and a corresponding first number of shares for the one or more keywords for trade in a market system;
program code for receiving an order for trade of a second number of shares corresponding to a given one of the one or more keywords, wherein the order for trade comprises an order value for the second number of shares corresponding to a given one of the one or more keywords;
program code for determining a market value for the second number of shares corresponding to the given one of the one or more keywords; and
program code for executing the order for trade for the second number of shares corresponding to the given one of the one or more keywords based upon the order value and the market value.

9. The computer readable media of claim 8 wherein program code for receiving an order for trade of a second number of shares corresponding to a given one of the one or more keywords comprises program code for receiving a market order for trade of the second number of shares corresponding to the given one of the one or more keywords, wherein the market order comprises a market order value that is equal to the market value.

10. The computer readable media of claim 9 wherein program code for executing the order for trade for the second number of shares corresponding to the given one of the one or more keywords based upon the order value and the market value comprises:
program code for executing the market order for trade for the second number of shares corresponding to the given one of the one or more keywords at the market value for the second number of shares corresponding to the given one of the one or more keywords.

11. The computer readable media of claim 8 wherein program code for receiving an order for trade of a second number of shares corresponding to a given one of the one or more keywords comprises program code for receiving a conditional order for trade of the second number of shares corresponding to the given one of the one or more keywords, wherein the conditional order comprises a minimum conditional order value and a maximum conditional order value.

12. The computer readable media of claim 11 wherein program code for executing the order for trade for the second number of shares corresponding to the given one of the one or more keywords based upon the order value and the market value comprises:
program code for determining whether the market value is greater than the minimum conditional order value;
program code for determining whether the market value is less than the maximum conditional order value;
program code for executing the conditional order for trade where the market value is greater than the minimum conditional order value and less than the maximum conditional order value.

13. The computer readable media of claim 8 wherein program code for receiving an order for trade of a second number of shares corresponding to a given one of the one or more keywords comprises program code for receiving a pair order for trade of the second number of shares corresponding to the given one of the one or more keywords, wherein the pair order comprises a minimum pair order value and a maximum pair order value for the second number of shares corresponding to the given one of the one or more keywords.

14. The computer readable media of claim 13, further comprising:
program code for receiving the pair order for trade for a third number of shares corresponding to a second one of the one or more keywords, wherein the pair order comprises a minimum pair order value and a maximum pair order value for the third number of shares corresponding to the second one of the one or more keywords;
program code for determining a market value for the third number of shares corresponding to the second one of the one or more keywords;
program code for determining whether the market value for the second number of shares corresponding to the given one of the one or more keywords is greater than the minimum pair order value for the second number of shares corresponding to the given one of the one or more keywords;
program code for determining whether the market value for the second number of shares corresponding to the given one of the one or more keywords is less than the maximum pair order value for the second number of shares corresponding to the given one of the one or more keywords;
program code for determining whether the market value for the third number of shares corresponding to the second one of the one or more keywords is greater than the minimum pair order value for the third number of shares corresponding to the second one of the one or more keywords;
program code for determining whether the market value for the third number of shares corresponding to the second one of the one or more keywords is less than the maximum pair order value for the third number of shares corresponding to the second one of the one or more keywords; and
program code for executing the pair order for trade where the market value is greater than the minimum pair order value for the second number of shares corresponding to the given one of the one or more keywords and for the third number of shares corresponding to the second one of the one or more keywords and less than the maximum pair order value for the second number of shares corresponding to the given one of the one or more keywords and for the third number of shares corresponding to the second one of the one or more keywords.

15. An electronic market system for trading keywords, the system comprising:
a trading server comprising an interface operative to, present one or more keywords and a corresponding first number of shares for the one or more keywords for trade in a market system;
a transaction processing module operative to receive an order for trade of a second number of shares corresponding to a given one of the one or more keywords, wherein the order for trade comprises an order value for the second number of shares corresponding to a given one of the one or more keywords;
a matching engine operative to determine a market value for the second number of shares corresponding to the given one of the one or more keywords; and
the transaction processing module operative to execute the order for trade for the second number of shares corresponding to the given one of the one or more keywords based upon the order value and the market value.

16. The system of claim 15 wherein the transaction processing module is operative to receive a market order for trade of the second number of shares corresponding to the given one of the one or more keywords, wherein the market order comprises a market order value that is equal to the market value.

17. The system of claim 16 wherein the transaction processing module is operative to execute the market order for trade for the second number of shares corresponding to the given one of the one or more keywords at the market value for the second number of shares corresponding to the given one of the one or more keywords.

18. The system of claim 15 wherein the transaction processing module is operative to receive a conditional order for trade of the second number of shares corresponding to the given one of the one or more keywords, wherein the conditional order comprises a minimum conditional order value and a maximum conditional order value.

19. The system of claim 18 wherein the transaction processing module is operative to:
determine whether the market value is greater than the minimum conditional order value;
determine whether the market value is less than the maximum conditional order value;
execute the conditional order for trade where the market value is greater than the minimum conditional order value and less than the maximum conditional order value.

20. The system of claim 15 wherein the transaction processing module is operative to receive a pair order for trade of the second number of shares corresponding to the given one of the one or more keywords, wherein the pair order comprises a minimum pair order value and a maximum pair order value for the second number of shares corresponding to the given one of the one or more keywords.

21. The system of claim 20, wherein the transaction processing module is operative to:
receive the pair order for trade for a third number of shares corresponding to a second one of the one or more keywords, wherein the pair order comprises a minimum pair order value and a maximum pair order value for the third number of shares corresponding to the second one of the one or more keywords;
determine a market value for the third number of shares corresponding to the second one of the one or more keywords;
determine whether the market value for the second number of shares corresponding to the given one of the one or more keywords is greater than the minimum pair order value for the second number of shares corresponding to the given one of the one or more keywords;
determine whether the market value for the second number of shares corresponding to the given one of the one or more keywords is less than the maximum pair order value for the second number of shares corresponding to the given one of the one or more keywords;
determine whether the market value for the third number of shares corresponding to the second one of the one or more keywords is greater than the minimum pair order value for the third number of shares corresponding to the second one of the one or more keywords;
determine whether the market value for the third number of shares corresponding to the second one of the one or more keywords is less than the maximum pair order value for the third number of shares corresponding to the second one of the one or more keywords; and
execute the pair order for trade where the market value is greater than the minimum pair order value for the second number of shares corresponding to the given one of the one or more keywords and for the third number of shares corresponding to the second one of the one or more keywords and less than the maximum pair order value for the second number of shares corresponding to the given one of the one or more keywords and for the third number of shares corresponding to the second one of the one or more keywords.
